(19) United States
(12) Patent Application Publication
(10) Pub. No.: US 2017/0088778 A1
(43) Pub. Date: Mar. 30, 2017

(54) ADJUSTING DEVICE FOR ACTUATING AN ELEMENT WITHIN A GAS CHAMBER THROUGH WHICH A COKE OVEN GAS FLOWS, AND METHOD FOR OPERATING THE ADJUSTING DEVICE

(71) Applicants: ThyssenKrupp Industrial Solutions AG, Essen (DE); ThyssenKrupp AG, Essen (DE)

(72) Inventors: Matthias Diephaus, Bochum (DE); Fabian Hegner, Bottrop (DE); Kerstin Überschär, Bochum (DE); Dirk Wienekamp, Selm (DE)

(73) Assignees: ThyssenKrupp Industrial Solutions AG, Essen (DE); ThyssenKrupp AG, Essen (DE)

(21) Appl. No.: 15/311,440

(22) PCT Filed: May 7, 2015
(86) PCT No.: PCT/EP2015/060064

§ 371 Date: Nov. 15, 2016

(30) Foreign Application Priority Data
May 21, 2014 (DE) 10 2014 107 174.3

(51) Int. Cl. C10B 27/06; F16J 15/52

(52) U.S. Cl. CPC C10B 27/06; F16J 15/52

(57) ABSTRACT

An actuating device may be used to operate an element inside a gas chamber through which coke-oven gas flows. The actuating device may include an actuating rod that can be connected to the element and may be arranged inside a raw gas manifold and guided to the outside through an opening. The actuating device may further include a cylinder/piston arrangement for creating axial actuating movements of the actuating rod. The actuating device may also include a device for sealing the actuating rod that is guided through the opening. The device for sealing the actuating rod may have a sealing sleeve that is arranged on an outer side of the raw gas manifold and is flexible in length. The device for sealing may further include a feed line for introducing a sealing medium into the interior space of the sealing sleeve. The sealing sleeve may be fixedly arranged at its one end and may enclose a gap between the actuating rod and the opening. At its other end, the sealing sleeve may be connected in a gastight manner to the actuating rod.

The invention relates to an actuating device for operating an element inside a gas chamber through which flows coke-oven gas, with an actuating rod, which can be connected to the element and is arranged inside a raw gas manifold and guided to the outside through an opening, a cylinder/piston arrangement for creating axial actuating movements of the actuating rod and a device for sealing the actuating rod which is guided through the opening.

A device of the described construction and with the specified intended purpose is known from DE 101 07 982 C1. The actuating rod is connected to an element which as a sealing/regulating element is associated with a drain opening on the underside of an immersion pot which is arranged in the gas chamber. Connected to the raw gas manifold is a gas pipe which dips into the immersion pot and has slot-like openings at its free end. By opening and closing movements of the sealing/regulating element the liquid level in the immersion pot can be adjusted and the free opening cross section of the slot-like openings can be altered. As a result, the volumetric flow of gas through the raw gas manifold and the pressure in a coking chamber, which is connected via the raw gas manifold to the gas offtake main, can be regulated. The actuating rod for operating the sealing/regulating element is guided to the outside through a shell-side opening of the raw gas manifold and connected to a cylinder/piston arrangement. For avoiding raw gas emissions, a seal is required between the actuating rod and the actuating rod which is guided through the opening. For the sealing, the printed document does not provide more detailed information. Stuffing box seals and sealing arrangements with one or more seals, which in practice are customary for sealing axially adjustable shafts and rods, are subjected to wear. Especially problematic are the high temperatures of the raw gas and entrained contaminants in the form of tar, coal dust and coke particles which make their way into the region of the seal and impair the function of the rod lead-through.

For the aforesaid application, a device for sealing an actuating rod which is guided through an opening and based on the principle of a hydraulic seal is known from DE 197 48 692 C1. The sealing arrangement comprises an immersion pot which is filled with liquid and also an immersion pipe which regardless of the travel range of the actuating rod always dips into the liquid bath inside the immersion pot. The immersion pot of the sealing arrangement is constantly supplied with liquid, wherein surplus liquid flows out as overflow or flows out through a bottom-side drain. The seal which is based on a hydraulic principle is located directly in the flow region of the raw gas which is contaminated with tar and also coal dust and coke particles, with the result that contaminants form deposits and make their way into the liquid bath of the immersion pot. A considerable consumption of liquid is required in order to maintain a correct function of the sealing principle which is based on a hydraulic seal.

Against this background, with an actuating device for the aforesaid application, the invention is based on the object of disclosing an effective seal of the actuating rod which is guided out of the raw gas manifold to the outside, which seal is unsusceptible to dirt as a result of contaminants entrained in the raw gas, and which operates with low wear. In comparison to a seal which is based on the principle of a hydraulic immersion, the consumption of operating media is to be significantly reduced.

The subject matter of the invention and the solution of this object is an actuating device according to claim 1.

According to the invention, the device for sealing the actuating rod has a sealing sleeve which is arranged on the outer side of the raw gas manifold and is flexible in length, and also a feed line for introducing a sealing medium into the interior space of the sealing sleeve. The sealing sleeve is fixedly arranged at its one end and encloses a gap between the actuating rod and the opening for the rod lead-through. At its other end, the sealing sleeve is connected to the actuating rod in a gastight manner. The sealing sleeve is arranged outside the raw gas manifold and is not exposed directly to the flow of the hot raw gas. The sealing sleeve is variable in length and by means of a change in length compensates the travel range of the actuating rod. The interior space of the sealing sleeve is isolated in a gastight manner in relation to the environment on the outer side of the raw gas manifold so that no raw gas emission can escape to the outside. The interior space of the sealing sleeve which is supplied with a sealing medium is under a pressure which is higher than the operating pressure inside the raw gas manifold. An overpressure, which prevents entry of raw gas and contaminants into the interior space of the sealing sleeve, correspondingly prevails in the annular gap between the actuating rod and the opening through which the actuating rod is guided. Also, the annular gap between the actuating rod and the associated opening is washed by means of the sealing medium which makes its way from the interior space of the sealing sleeve into the flow chamber of the raw gas manifold.

The sealing medium can be in liquid or gaseous form. The use of a gaseous sealing medium, for example nitrogen, is preferred. A low overpressure inside the sealing sleeve is sufficient in order to ensure the function of the seal arrangement. The overpressure is selected so that the sealing medium flowing into the raw gas manifold does not falsify any pressure measurements inside the raw gas manifold.

Since the sealing sleeve is arranged on the outer side of the pipe manifold, the sealing sleeve is not subjected to any particular temperature loads so that the sealing sleeve can be produced from current plastics. The sealing sleeve is preferably designed as a bellows.

The feed line for the sealing medium can be connected to an adapter which encompasses the actuating rod with a gap. The fixedly arranged end of the sealing sleeve is expediently connected to the adapter. A further advantageous embodiment provides that the adapter is fastened to a cover by means of which an inspection opening of the raw gas manifold can be closed off.

The actuating rod and the end of a piston rod of the cylinder/piston arrangement are connected by means of a coupling which can be designed as a quick-release coupling. The sealing sleeve is expediently connected to a connecting end of the coupling.

A further advantageous aspect of the invention provides that a preheated gas or a preheated liquid is used as sealing medium. As gaseous sealing medium, nitrogen is preferably used. As a result of preheating the sealing medium, the effect of the actuating rod being cooled by thermal conduction and contaminants of the raw gas being deposited as condensate can be prevented. The sealing medium, before being introduced into the interior space of the sealing sleeve, is expediently preheated by means of exchange of heat with a raw gas stream flowing through the raw gas manifold. Preheating to about 70 to 90° C. is sufficient in order to avoid tar condensing out of the raw gas stream.

In the following text, the invention is explained with reference to a drawing which represents only an exemplary embodiment. Schematically, in the drawing

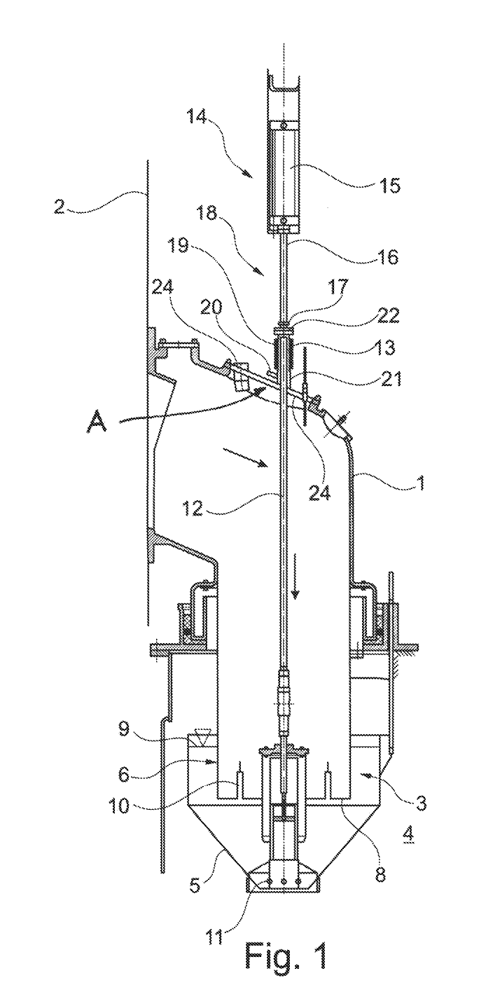

FIG. 1 shows an actuating device for operating a sealing/regulating element inside a gas chamber through which flows a coke-oven gas,

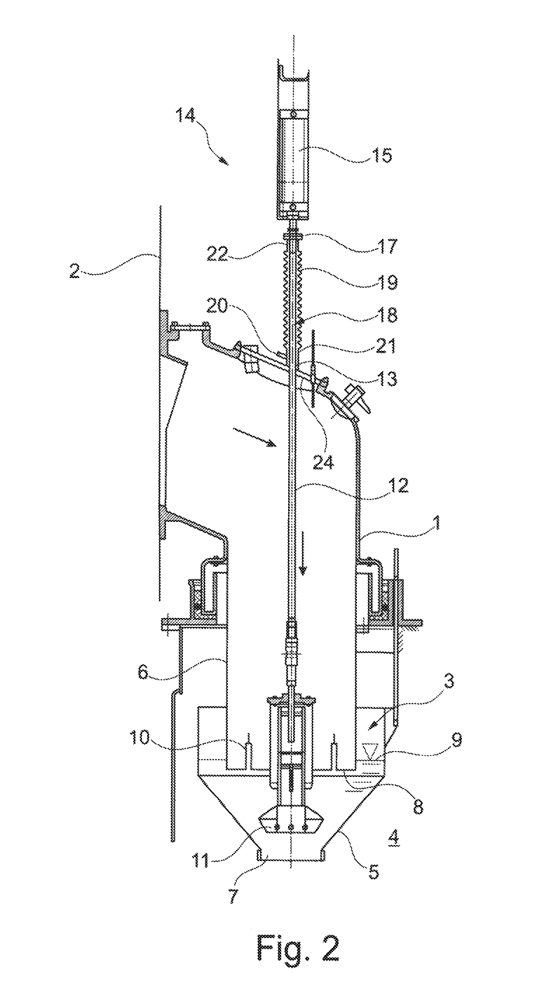

FIG. 2 shows another functional position of the device shown in FIG. 1,

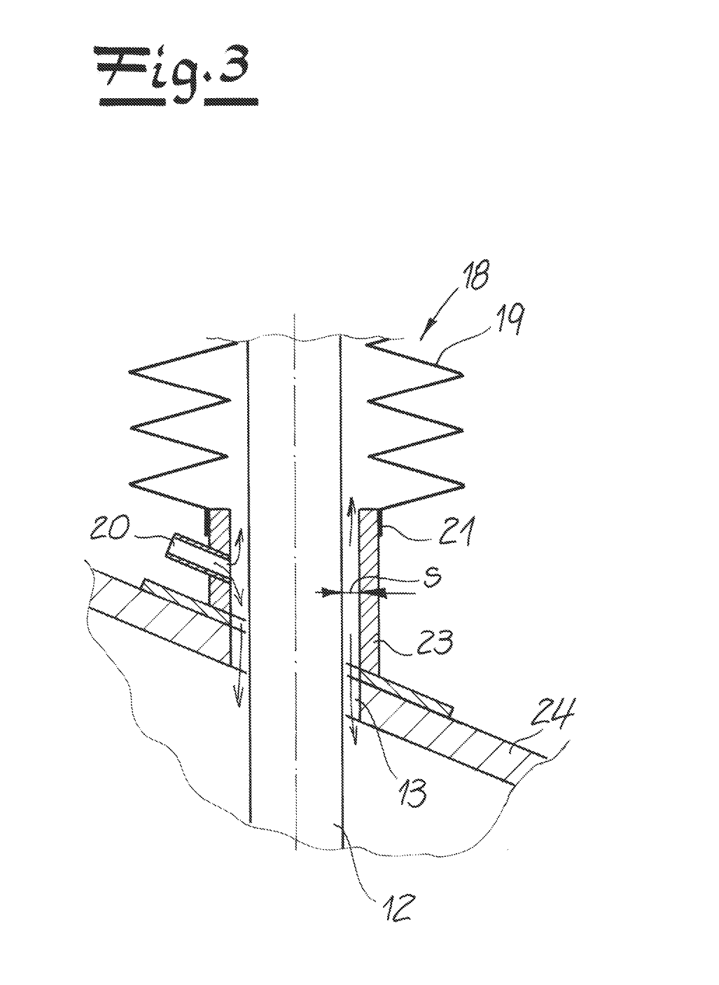

FIG. 3 shows the detail A from FIG. 1.

Shown in FIG. 1 is a raw gas manifold 1 which by its upper end is connected to an only indicated riser pipe 2 and through which flows, in the indicated flow direction, a raw gas which is extracted from a coke-oven chamber. The gas flow is adjustable and variable by means of a throttling device 3. The throttling device 3 is arranged inside a gas chamber 4 through which flows coke-oven gas and via the raw gas manifold 1 and the riser pipe 2 is connected to the gas collecting chamber of a coking chamber. The gas chamber 4 can especially be a gas offtake main of a coke oven comprising a plurality of coke-oven chambers or a flow chamber adjoining the gas offtake main. An immersion pot 5, to which water is constantly fed, and an immersion pipe 6, which is connected to the raw gas manifold 1 and terminates in the immersion pot 5, are part of the basic construction of the throttling device 3. The immersion pot 5 has a water overflow and a closable drain 7. The immersion pipe 6 is formed with an end section 8, the free gas discharge cross section of which is dependent on the liquid level 9 in the immersion pot 5. In the exemplary embodiment, the end section 8 has shell-side slots 10.

For closing off the drain 7 which is arranged on the underside of the immersion pot 5, provision is made for an element 11 as a sealing/regulating element which is connected to an actuating rod 12. The actuating rod 12 is arranged inside the raw gas manifold 1 and guided through an opening 13 to the outside. For operating the actuating rod 12, provision is made for a cylinder/piston arrangement 14 which has a control cylinder 15 and a piston with a piston rod 16. The piston rod 16 and the actuating rod 12 are connected outside the raw gas manifold 1 by means of a coupling 17 which can be designed as a quick-release coupling.

For avoiding raw gas emissions, provision is made for a device 18 for sealing the actuating rod which is guided through the opening. This device 18 comprises a sealing sleeve 19 which is arranged on the outer side of the raw gas manifold 1 and is flexible in length, and also a feed line 20 for introducing a gaseous sealing medium into the interior space of the sealing sleeve 19. The sealing sleeve 19 is fixedly arranged at its one end 21 and encloses a gap between the actuating rod 12 and the opening 13. At its other end 22, the sealing sleeve 19 is connected in a gastight manner to the actuating rod 12.

The sealing sleeve 19 is designed as a bellows which by means of a change in length compensates a travel range of the actuating rod between the first position shown in FIG. 1 and a second position shown in FIG. 2. The interior space of the sealing sleeve 19, which is supplied with a gaseous or liquid sealing medium, is under a slightly higher pressure than the operating pressure inside the raw gas manifold 1 so that no raw gas makes its way into the interior space of the bellows on account of the pressure difference. The annular gap between the actuating rod 12 and the opening 13, through which the actuating rod is guided to the outside, is also washed with the sealing medium which enters the interior space of the raw gas manifold 1 and keeps the annular gap free of deposits.

To be gathered from the exemplary embodiment shown in the figures is that the feed line 20 for the sealing medium is connected to an adapter 23 which encompasses the actuating rod 12 with a gap s and to which the fixedly arranged end of the sealing sleeve 19 is connected in a fixed and gastight manner (FIG. 3). The adapter 23 is fastened to a cover 24 by means of which an inspection opening of the raw gas manifold 1 can be closed off.

As sealing medium, a preheated gas is preferably used, wherein the gas can be nitrogen or another inert gas. By preheating the sealing medium, the effect of the actuating rod 12 being cooled as a result of thermal conduction and condensate forming on the surface of the actuating rod 12 is prevented. By heating the sealing medium to 70 to 90° C., condensing out of tar can be effectively prevented. The sealing medium, before being introduced into the interior space of the sealing sleeve 19, is expediently preheated to about 70 to 90° C. by exchange of heat with the raw gas flowing through the raw gas manifold 1.

1.-9. (canceled)

10. An actuating device for operating an element inside a gas chamber through which coke-oven gas flows, the actuating device comprising:
an actuating rod that is connectable to the element and that is positioned inside a raw gas manifold and guided to an outside of the raw gas manifold through an opening;
a cylinder/piston arrangement for creating axial actuating movements of the actuating rod; and
a device for sealing the actuating rod that is guided through the opening, the device including a sealing sleeve that is positioned on an outer side of the raw gas manifold and is flexible in length, the device further including a feed line for introducing a sealing medium into an interior space of the sealing sleeve, wherein the sealing sleeve is fixedly arranged at its first end and encloses a gap between the actuating rod and the opening, wherein the sealing sleeve at its second end is connected to the actuating rod in a gas-tight manner.

11. The actuating device of claim 10 wherein the sealing sleeve is configured as a bellows.

12. The actuating device of claim 10 wherein the feed line is connected to an adapter that encompasses the actuating rod with a gap, wherein the first end of the sealing sleeve is connected to the adapter.

13. The actuating device of claim 12 wherein the adapter is fastened to a cover by way of which an inspection opening of the raw gas manifold can be closed off.

14. The actuating device of claim 10 wherein the actuating rod and an end of a piston rod of the cylinder/piston arrangement are connected by a coupling.

15. The actuating device of claim 14 wherein the sealing sleeve is connected to a connecting end of the coupling.

16. A method of operating an actuating device for operating an element inside a gas chamber through which coke-oven gas flows, the actuating device comprising an actuating rod that is connectable to the element and that is positioned inside a raw gas manifold and guided to an outside of the raw gas manifold through an opening, a cylinder/piston arrangement for creating axial actuating movements of the actuating rod, and a device for sealing the actuating rod that is guided through the opening, the device including a sealing sleeve that is positioned on an outer side of the raw gas manifold and is flexible in length, the device further including a feed line for introducing a sealing medium into an interior space of the sealing sleeve, wherein the sealing sleeve is fixedly arranged at its first end and encloses a gap between the actuating rod and the opening, wherein the sealing sleeve at its second end is connected to the actuating rod in a gas-tight manner, wherein the method comprises using a preheated gas or a preheated liquid as the sealing medium.

17. The method of claim 16 wherein nitrogen is used as the sealing medium.

18. The method of claim 16 further comprising preheating the sealing medium by exchanging heat with a raw gas stream flowing through the raw gas manifold, wherein the preheating occurs before the sealing medium is introduced into the interior space of the sealing sleeve.
